(19) United States
(12) Patent Application Publication
(10) Pub. No.: US 2023/0014948 A1
(43) Pub. Date: Jan. 19, 2023

(54) MICROWAVE IDENTIFICATION METHOD AND SYSTEM

(71) Applicant: METIS IP (SUZHOU) LLC, Suzhou (CN)

(72) Inventor: Shan GUAN, Shanghai (CN)

(73) Assignee: METIS IP (SUZHOU) LLC, Suzhou (CN)

(21) Appl. No.: 17/929,746

(22) Filed: Sep. 5, 2022

Related U.S. Application Data
(63) Continuation of application No. PCT/CN2020/077602, filed on Mar. 3, 2020.

(51) Int. Cl. G06V 20/52; G06V 10/44; G06V 10/75; G06V 40/10; G06T 7/73; G06V 40/20; G01S 13/90

(52) U.S. Cl. CPC G06V 20/52; G06V 10/44; G06V 10/751; G06V 40/15; G06T 7/75; G06V 40/25; G01S 13/9021; G06T 2207/30196; G06T 2207/30232

(57) ABSTRACT

The present disclosure discloses a microwave identification method, which is implemented on at least one device, including at least one processor and at least one storage device, the method including: the at least one processor obtains microwave data; the at least one processor generates an image of one or more objects based on the microwave data; the at least one processor obtains a model of each of the one or more objects; and based on the model of each of the one or more objects, the at least one processor identifies the one or more objects in the image of the one or more objects.

### CROSS-REFERENCE TO RELATED APPLICATION

This application is a continuation of International Application No. PCT/CN2020/077602, filed on Mar. 3, 2020, the contents of which are incorporated herein by reference to their entirety.

### TECHNICAL FIELD

The present disclosure relates to an intelligent identification system, and more particularly, relates to a method and system for identifying an object based on a microwave signal.

### BACKGROUND

In recent years, security problems, especially intrusions, in different occasions cause great attention. Therefore, there is a need for an identification system for monitoring and identifying objects and triggering security alarms automatically and in real time.

### SUMMARY

One aspect of the present disclosure provides a microwave identification method, which is implemented on at least one device, including at least one processor and at least one storage device, the method including: the at least one processor obtains microwave data; the at least one processor generates an image of one or more objects based on the microwave data; the at least one processor obtains a model of each of the one or more objects; and based on the model for each of the one or more objects, the at least one processor identifies one or more objects in the image of the one or more objects.

Another aspect of the present disclosure provides a system, which includes an obtaining unit to obtain microwave data; an image generating unit to generate an image of one or more objects based on the microwave data; a modeling unit to obtain a model of each of the one or more objects; and an identification unit to identify the one or more objects in the image of the one or more objects based on the model for each of the one or more objects.

Another aspect of the present disclosure provides a system, which includes at least one storage device to store instructions and at least one processor; when the processor performs the instruction, the system is made to obtain microwave data; generate an image of one or more objects based on the microwave data; obtain a model of each of the one or more objects; and identify the one or more objects in the image of the one or more objects based on the model for each of the one or more objects.

Another aspect of the present disclosure provides a computer-readable storage medium storing a computer instruction that makes a computer implement a method including: obtaining microwave data; generating, based on the microwave data, an image of one or more objects; obtaining a model of each of the one or more objects; and identifying, based on the model for each of the one or more objects, the one or more objects in the image of the one or more objects.

In some embodiments, the model of each of the one or more objects may be determined according to a radar cross section (RCS) model construction approach, the method includes: obtaining an image of one of the one or more objects and extracting one or more features from the image of the object; and constructing a model of the object based on the one or more features.

In some embodiments, the image may be a two-dimensional (2D) image that includes one or more points, and each of the one or more points represents a scattering source.

In some embodiments, the microwave data may be obtained through one or more microwave radars.

In some embodiments, the method further includes: performing a preprocessing on the microwave data obtained by the at least one processor.

In some embodiments, the preprocessing includes at least one of an analog to digital (A/D) conversion, a Fourier transform, a noise reduction processing, or a dark current processing.

In some embodiments, the identifying the one or more objects in the image of the one or more objects based on the model for each of the one or more objects includes: extracting one or more features from the image; comparing the one or more features with a feature of the model for each of the one or more objects; and identifying the one or more objects in the image based on the comparison.

In some embodiments, the method further includes: determining that the one or more objects in the image includes a human body; and generating warning information in response to determining that the one or more objects in the image includes a human body.

In some embodiments, the one or more features include at least one of a contour, a shape, a size, a texture, a moving speed, a moving frequency, or a moving displacement.

In some embodiments, the image may be generated based on a range-Doppler approach.

In some embodiments, the image includes a dynamic image or a plurality of static images at different time instants.

In some embodiments, the model of each of the one or more objects includes a model of a target static object, the method further includes: identifying, by the at least one processor, the target static object in the image based on the model of the target static object; and constructing, by the at least one processor, an electronic fence based on the target static object.

In some embodiments, the model of each of the one or more objects includes at least one posture model of a moving human body, the method further includes: identifying, by the at least one processor, at least one posture of the moving human body in the image based on the at least one posture model of the moving human body.

In some embodiments, the model of each of the one or more objects includes a gait model of at least one target human body, the method further including: identifying, by the at least one processor, the at least one target body in the image based on the gait model of the at least one target human body.

In some embodiments, the gait model includes at least one of a step size, a gait frequency, or a gait phase.

In some embodiments, the model of each of the one or more objects includes a physiological parameter model of a human body, the method further comprising: determining, by the at least one processor, a physiological parameter of the human body in the image based on the physiological parameter model of the human body, wherein the physiological parameter includes at least one of a heart rate, a respiratory parameter, or a blood pressure.

Some additional features of the present disclosure may be explained in the following description. Through the inspection of the following descriptions and the corresponding drawings or the understand of the production or operation of the embodiments, some of the additional features of the present disclosure may be obvious to those skilled in the art. The features of the present disclosure may be implemented and achieved by the practice or use of various aspects, means, and combination of the specific embodiments described below.

### BRIEF DESCRIPTION OF THE DRAWINGS

The drawings may be used for further understanding of the present disclosure, and may form a part of the present disclosure. The schematic embodiments and their descriptions may be used to illustrate the present disclosure, and may not form a limitation for the present disclosure.

FIG. 1 is a schematic diagram illustrating an application scenario for a microwave identification system according to some embodiments of the present disclosure;

FIG. 2A is a module diagram illustrating a controller according to some embodiments of the present disclosure;

FIG. 2B is a schematic diagram illustrating a specific processing device according to some embodiments of the present disclosure;

FIG. 3 is a schematic diagram illustrating a mobile terminal according to some embodiments of the present disclosure, the mobile terminal may be configured to implement a specific system disclosed in the present disclosure;

FIG. 4A is a module diagram illustrating a detector according to some embodiments of the present disclosure;

FIG. 4B is a schematic diagram illustrating a beam control low sidelobe antenna according to some embodiments of the present disclosure.

FIG. 4C is a schematic diagram illustrating a phased array main lobe narrow beam electronically controlled scanning according to some embodiments of the present disclosure;

FIG. 4D is a schematic diagram illustrating a transmit and receive pulse waveform of an antenna according to some embodiments of the present disclosure;

FIG. 5 is a schematic diagram illustrating a processing module according to some embodiments of the present disclosure;

FIG. 6 is a schematic diagram illustrating a modeling unit according to some embodiments of the present disclosure;

FIG. 7 is a schematic flowchart illustrating a construction of a specific object model according to some embodiments of the present disclosure;

FIG. 8A is a schematic flowchart illustrating a microwave signal identification system according to some embodiments of the present disclosure;

FIG. 8B is an image of a pet dog in a plurality of moments generated based on microwave data according to some embodiments of the present disclosure;

FIG. 8C is three human body images generated based on the microwave data according to some embodiments of the present disclosure;

FIG. 8D is a schematic diagram illustrating a human posture learning analysis according to some embodiments of the present disclosure;

FIGS. 8E and 8F are schematic diagrams illustrating a human gait learning analysis according to some embodiments of the present disclosure;

FIGS. 8G and 8H are schematic diagrams illustrating a human heart rate and respiration analysis according to some embodiments of the present disclosure;

FIG. 9 is a schematic flowchart illustrating an object identification based on a model according to some embodiments of the present disclosure;

FIG. 10 is a schematic diagram illustrating a circuit connection according to some embodiments of the present disclosure;

FIG. 11 is a schematic diagram illustrating the connection circuit between a controller and the detector according to some embodiments of the present disclosure; and

FIG. 12 is a schematic diagram illustrating a circuit configuration of a microwave radar according to some embodiments of the present disclosure.

### DETAILED DESCRIPTION

As shown in the present disclosure and the claims, the terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or assemblies, but do not preclude the presence or addition of one or more other features, integers, steps, operations, elements, assemblies, and/or groups thereof.

Although the present disclosure has made various citations on some modules of a system in the embodiments of the present disclosure, any count of different modules may be used and operated in the security system. These modules are only for the purpose of explanation, and different modules may be used in different aspects of the system and method.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added into the flowcharts. One or more operations may be removed from the flowcharts.

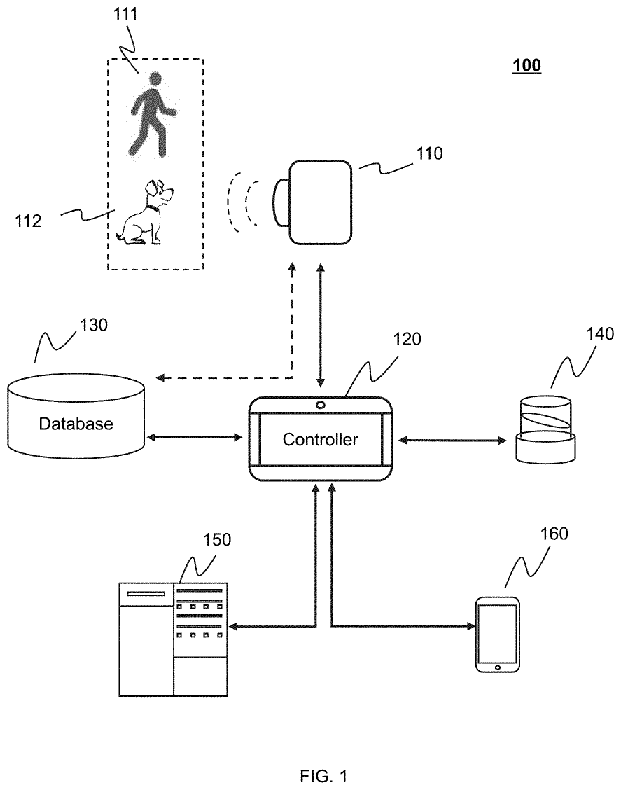

FIG. 1 is a schematic diagram illustrating an application scenario for a microwave identification system according to some embodiments of the present disclosure. A microwave identification system 100 may include a detector 110, a controller 120, a database 130, an alarm 140, a server 150, and a terminal device 160. The controller 120 may communicate with the detector 110, the database 130, the alarm 140, the server 150, and the terminal device 160.

The detector 110 may obtain information from an object in a surrounding environment. The object may include a human 111, an animal 112, a rotating fan, and a sweeping robot, etc. The detector 110 may be any one or combination of a microwave radar, a microwave sensor, an optical sensor, an image sensor, a sound sensor, an infrared sensor, etc. The microwave radar or the microwave sensor may adopt centimeter waves, millimeter waves, etc. In some embodiments, the microwave radar or the microwave sensor may adopt millimeter waves. The millimeter waves have a strong environmental immunity, a strong material penetration, a wide scan bandwidth, and a high far-field resolution. The sound sensor may be an ultrasonic sensor, a microphone, etc. A signal obtained by the detector 110 may include a microwave signal, an infrared signal, an image signal, an ultrasonic signal, an audio signal, an optical signal, etc. In some embodiments, the detector 110 may be a microwave radar detector. The signal obtained by the detector 110 may be a microwave signal. The microwave signal may be used to identify a moving object in the surrounding environment. For example, the microwave radar may send microwaves to the surrounding environment, and determine whether there is a specific object (such as a human body) in the environment through a reflection of the moving object in the surrounding environment. For another example, the microwave radar may realize a still human and a human physiological parameter detection based on a micro-motion parameter of a breathing and heartbeat of the human body and according to a micro-Doppler fast Fourier transform, a Gaussian filtering algorithm, and an autocorrelation entropy algorithm (e.g., a monitoring on a heart rate, and a breathing).

The controller 120 may establish a communication connection with the detector 110, and use the detector 110 to perform monitoring and information collection on the object in the surrounding environment. The controller 120 may perform an analyze processing and/or a logical judgment (e.g., determining whether there is a foreign object invasion) on the information collected, and generate controlling or decision-making information. For example, the detector 110 may transmit the information obtained to the controller 120, the controller 120 may determine that there is a foreign object invasion, generate a control instruction, and transmits the control instruction to the alarm 140, the alarm 140 may alarm and warn the foreign object when receiving the control instruction.

The controller 120 may process a signal or information, generate a decision and a control instruction, etc. The controller 120 may perform processing or/and make a logical judgment on a signal or information received, and generate control decision information. The signal or information received may be directly output by the detector 110, which is unprocessed, or the signal or information may be output by the detector 110 after a preprocessing. The controller 120 may be perform processing on the signal or data received through one or more approaches, the one or more processing approaches may include a fitting, an interpolation, a discrete, an analog-digital conversion, a Z transform, a Fourier transform, a fast Fourier transform, a binarization adaptive mean filtering, a low-pass filter, a Gaussian filtering, a Kalman filtering, a contour identification, a feature extraction, an image segmentation, an image enhancement, an image reconstruction, a non-uniformity correction, an approach identification machine learning KNN (K-Nearest Neighbor) algorithm, a PCA (Principal Component Analysis) algorithm, a target aggregation algorithm, a target detection algorithm, a time difference positioning algorithm, a phase comparative positioning algorithm, etc. For example, the microwave signal received by the detector may be a time domain signal, and the controller 120 may transform the time domain signal to a frequency domain signal through the Fourier transform. For another example, for the microwave signal obtained, the controller 120 may implement a multi-posture detection of the human body based on the binarization adaptive mean filtering, the approach identification machine learning KNN algorithm, and the PCA algorithm. For another example, for the microwave signal obtained, the controller 120 may perform a motion tracking on a multi-target speed and ranging based on the target aggregation algorithm, the target detection algorithm, the time difference positioning algorithm, and the phase comparative positioning algorithm, and through the Kalman filtering, thereby achieving an accurate positioning of multi-target human body and a posture identification of multi-target human body. For another example, the controller 120 may perform a scanning dictation on a target static object indoor (e.g., a wall, a plant, a decoration, or other static object) based on a range-Doppler two-dimensional millimeter wave imaging and a Fourier analysis algorithm and the autocorrelation entropy algorithm to achieve a self-adaptive electronic fence function.

The processing device 120 may further receive information passively. In some embodiments, the controller 120 may receive a user instruction sent by the terminal device 160, and generate control information or instruction according to the user instruction. For example, the controller 120 may transfer a signal processing result to the terminal device 160, and request the user to confirm whether there is a foreign object invasion. After the user confirms that there is a foreign object, the confirmation information may be input to the terminal device 160, and the terminal device 160 may transmit the confirmation information to the controller 120, the controller 120 may generate the control instruction according to the confirmation information.

The controller 120 may be a processing component or device. For example, the controller 120 may include a central processing unit (CPU), a graphics processing unit (GPU), a digital signal processor (DSP), a system on a chip (SoC), a microcontroller unit (MCU), etc. For another example, the controller 120 may include a tablet, a mobile terminal, or a computer. For another example, the controller 120 may be a specially designed processing element or device with a special function.

The controller 120 may be connected with the database 130. The controller 120 may transfer the information after analysis to the database 130. The database 130 may organize, store, and manage the information. In some embodiments, the controller 120 may call or delete information within the database 130. For example, after the controller 120 processes the information of one or more objects obtained by the detector 110 from the surrounding environment, the controller 120 may generate a model of each of the one or more objects, and transmit the one or more models to the database 130 for storage. For another example, the controller 120 may obtain information of a moving object in the surrounding environment and process the information to generate an image of the moving object. The controller 120 may call a plurality of models stored in the database 130, and compare an image feature of the moving object with a feature of the plurality of models, thereby identifying the moving object. In some embodiments, the database 130 may be directly connected with the detector 110, and the detector 110 may pre-process the information and directly send the processed information to the database 130.

The alarm 140 may be configured to perform an alarm warning about a foreign object. When the controller 120 determines that there is the foreign object invasion, the control instruction may be generated and sent to the alarm 140, and the alarm 140 may issue an alarm warning according to the instruction. In some embodiments, the alarm 140 may make alarm warning in a form of whistle and flashing according to the instruction, such as turning on an alarm flashing light, an alarm speaker, and a buzzer, etc. For example, the controller 120 may determine that a foreign object has invaded the electronic fence based on the distance-Doppler two-dimensional millimeter wave imaging, and the alarm 140 may issue an alarm warning.

The controller 120 may be connected with the server 150, the server 150 may be cloud-based, and the server 150 may perform operations like an information retrieval, an information processing and an information storing, etc. In some embodiments, the controller 120 may transmit information to the server 150, and the server may store the information or further process the information. In some embodiments, the controller 120 may obtain information from the server 150. For example, the server 150 may transfer a retrieved result to the controller 120 after the operation of information retrieval is performed.

The controller 120 may be connected with the terminal device 160. The controller 120 may transfer information to the terminal device 160, the information may include a decision made by the controller 120, working status information of the alarm 140, or other information requested by the user. The controller 120 may further receive user inputs through terminal devices 160, including the control instruction, a parameter setting, etc. The terminal device may include a mobile phone, a tablet, a laptop, a smart wearable device (such as a smart watch, a pair of smart glasses, a headset monitor, etc.).

In some embodiments, the controller 120 may include a protective shell and a panel. The protective shell may have a certain aesthetic or concealment, and may be waterproof, moisture proof, shockproof, or impact resistant. The panel may further include an input/output (I/O) interface. The I/O interface may provide an interface for the user to input information to the controller 120 and/or for the controller 120 to out information to the user. In some embodiments, the I/O interface may be a touch screen.

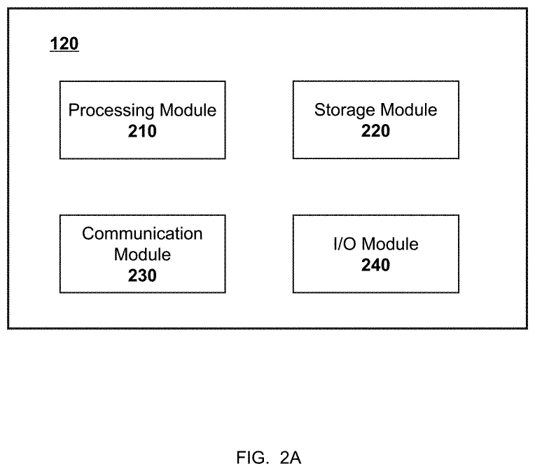

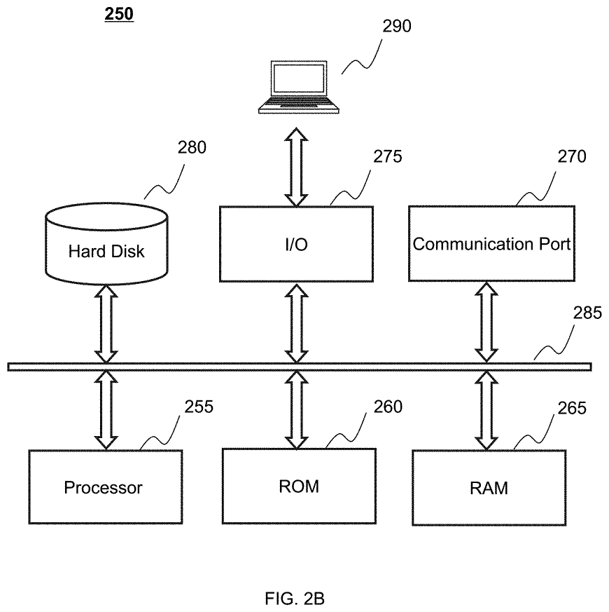

FIG. 2A is a module diagram illustrating a controller according to some embodiments of the present disclosure. The controller 120 may include a processing module 210, a storage module 220, a communication module 230, and an I/O module 240.

The processing module 210 may receive a signal, process a signal, generate a decision or a control instruction, etc. The processing module 210 may perform a processing or/and make a logical judgment on the signal or information received, and generate control decision information. The processing module 210 may receive the signal from the detector 110. The signal may be one or more of a microwave signal, an image signal, an infrared signal, a sound signal, an optical signal, etc. The signal may be a discrete digital signal or an analog signal with a certain waveform. The microwave signal may be a centimeter wave microwave signal, a millimeter wave microwave signal, etc. The sound signal may be an ultrasonic signal, a normal sound wave signal (a sound signal that may be heard by a human ear), an infrasound signal, etc.

In some embodiments, the processing module 210 may generate an image through processing the above signal, and compare a feature of the image with a feature of the model to identify an object in the image as a specific object, such as a human body. The processing module 210 may process the signal and extract valid information through one or more approaches. The one or more processing approaches may include a numerical calculation, a waveform processing, an image processing, etc. A numerical calculation approach may include a PCA (principal component analysis), a fitting, an iteration, a discrete, an interpolation, an approach identification machine learning KNN algorithm, a PCA algorithm, etc. The waveform processing approach may include an analog-digital conversion, a wavelet transform, a Fourier transform, a fast Fourier transform, a low-pass filtering, a binarization adaptive mean filtering, a Gaussian filtering, a Kalman filtering, etc. An image processing approach may include a moving target identification, an image segmentation, an image enhancement, an image reconstruction, a non-uniformity correction, a target aggregation algorithm, a target detection algorithm, a time difference positioning algorithm, a phase comparative positioning algorithm, etc. In some embodiments, the processing module 210 may process the microwave signal to obtain a processing result. The processing result may include whether there is a moving object in the environment, whether the moving object include a human body, fixed frequency component information of the moving object, and a frequency domain signal after filtering the fixed frequency. In some embodiments, the processing module 210 may process the image signal. The processing result may include information such as a texture feature, shape features, contour features, and size features of the image. In some embodiments, the image signal may be a dynamic image signal (for example, a continuously collected image signal within a certain period of time). The processing module 210 may process the image signal. For example, the processing result may include determining a static object and build a self-adaptive electronic fence. For another example, the processing result may include identifying at least one posture of the human body (walking, sitting down, squatting, lying down, falling, etc.). For another example, the processing result may include monitoring a physiological parameter of the human body on a distant field (such as a heart rate, a respiratory, a blood pressure, etc.) so that a monitoring on a physical condition of the elderly in a scenario of smart elderly care. For another example, the processing result may include identifying a human gait, identifying the gait of a target human body (such as different gaits of different family members), and then realizing an identification of each family member. For another example, the processing result may include identifying a static human body.

The processing module 210 may further perform logical process on the information obtained and generate a decision or a control instruction, etc. For example, after processing the information of the moving object obtained, the processing module 210 may generate a decision or a control instruction that the moving object is an invader, and the control instruction may be sent to the alarm 140, the alarm 140 may perform an alarm warning after receiving the control instruction.

In some embodiments, the processing module 210 may include a microprocessor, a single-chip micro-computer, a programmable logic controller, a digital signal processor, or a special designed processing element or device with special functions.

The storage module 220 may be configured to store information. The information may include information obtained by processing module 210, the processing result generated by processing module 210, the instruction, and received information input by the user transmitted by the terminal device 160. The form of storage module 220 may be a text, a number, a sound, an image, etc. In some embodiments, the information stored in the storage module 220 may be the processing result of the processing module 210, such as the microwave signal, a time domain feature of the sound signal, a color, a texture, a shape, and a contour of the image. In some embodiments, the information stored in the storage module 220 may be provided to the processing module 210. In some embodiments, the storage module 220 may include but not limited to various common storage devices such as a solid-state drive (SSD), a mechanical hard disk, a USB flash storage device, an SD storage device card, a CD, a random-access memory (RAM) and a read-only memory (ROM), etc. In some embodiments, the storage module 220 may be the storage device inside the controller 120, the external storage device of the controller 120, the network storage device other than the controller 120 (such as the storage device on the storage server, etc.).

The communication module 230 may establish a communication connection between the controller 120 and other assemblies in the microwave identification system 100. Away of the communication may include a wired communication and a wireless communication. The wired communication may include communicating through a transmission medium such as a wire, a cable, an optical cable, a waveguide, a nanomaterial. The wireless communication may include an IEEE 802.11 series wireless LAN communication, an IEEE 802.15 series wireless communication (such as a Bluetooth, a ZigBee, etc.), a mobile communication (such as a TDMA, a CDMA, a WCDMA, a TD-SCDMA, a TD-LTE, a FDD-LTE, etc.), a satellite communication, a microwave communication, a scattering communication, a radio frequency communication, an infrared communication, etc. In some embodiments, the communication module 230 may use one or more encoding approaches to encode the transmitted information. The encoding approach may include a phase encoding, a non-return-to-zero code, a differential Manchester code, etc. In some embodiments, the communication module 230 may choose different transmission and encoding approaches according to the different types of data or networks that need to be transmitted. In some embodiments, the communication module 230 may include one or more communication interfaces, such as an RS485, an RS232, etc. The controller 120 may implement a bidirectional or unidirectional data communication with other assemblies through the communication module 230. For example, the controller 120 may transmit the signal or the processing result obtained to the terminal device 160 through the communication module 230, and request the user to confirm whether there is a foreign object invasion. After the user inputs a user instruction through the terminal device 160, the module 230 may transmit the user instruction to the controller 120.

The I/O module 240 may support a data stream input and/or output between the controller 120 and other assemblies (such as the storage module 220), and/or the other assemblies in the microwave identification system 100 (such as the database 130). In some embodiments, when the controller 120 has a control requirement, a switching signal may be provided through the I/O module 240, or a switching signal may be provided through the I/O module 240, so that the controlled assembly may act, and the controller 120 may obtain a feedback signal of the controlled assembly through the I/O module 240 at the same time. For example, after the processing module 210 processes information of the moving object obtained, a determination that the moving object is an invaded foreign object may be made, and a control instruction may be generated. The controller 120 may send the instruction to the alarm 140 through the I/O module 240. After the alarm 140 starts the alarm warning, the controller 120 may receive working status information transmitted by the alarm 140 through the I/O module.

FIG. 2B is a schematic diagram illustrating a specific processing device according to some embodiments of the present disclosure. The processing device 200 may implement one or more assemblies, modules, units, and sub-units (such as the controller 120, the alarm 140, etc.) in the current microwave identification system 100. In addition, the one or more assemblies, modules, units, and sub-units (such as the controller 120, the alarm 140, etc.) may be implemented by the processing device 200 through its hardware device, software program, or a combination thereof. A computer may be a computer for general use, or a computer with a specific purpose. Both types of computer may be used to implement a specific system in the present disclosure. For the convenience of description, only one computer device is drawn in FIG. 2B, but the related computer function of information processing and information pushing described in the embodiment may be implemented in a distributed manner by a group of similar platforms to disperse a processing load of the system.

According to FIG. 2B, the processing device 250 may include an internal communication bus 285, a processor 255, a read-only memory (ROM) 260, a random-access memory (RAM) 265, a communication port 270, an I/O assembly 275, a hard disk 280, a user interface 290. The internal communication bus 285 may implement a data communication in the assembly of the processing device 250. The processor 255 may perform a program instruction to complete the one or more functions, assemblies, modules, units, sub-units of the microwave identification system 100 described in the present disclosure. The processor 255 may consist one or more processors. The communication port 270 may be configured to implement the data communication between the processing device 250 and the other parts (such as the controller 120) of the microwave identification system 100 (such as through the communication module 230). The processing device 250 may further include different forms of program storage units and data storage units, such as the hard disk 280, the ROM 260, the RAM 265, varies types of data files used in computer processing and/or communication, and the possible program instruction performed by the processor 255. The I/O assembly may support the data stream input and/or output between the processing device and other assemblies, and/or other assemblies of the microwave identification system 100 (such as the database 130). The processing device 250 may further send and receive data and information with the controller 120 through the communication port 270.

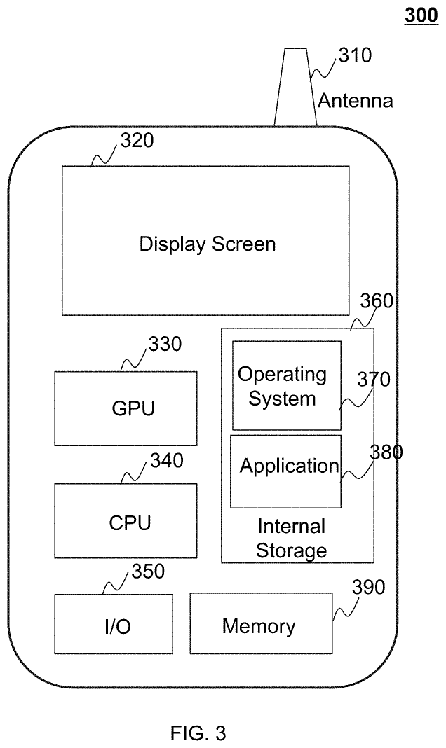

FIG. 3 is a schematic diagram illustrating a mobile terminal according to some embodiments of the present disclosure, the mobile terminal may be configured to implement a specific system disclosed in the present disclosure. In this embodiment, a user device for displaying information about interacting with a user may be a mobile device 300. The mobile device 300 may include a smartphone, a tablet, a music player, a PlayStation portable, a global positioning system (GPS) receiver, a wearable computing device (such as a pair of glasses, a watch, etc.), or other forms of device. The mobile device 300 in the embodiment includes one or more central processing units (CPUs) 340, one or more graphical processing units (GPUs) 330, a display screen 320, an internal storage 360, an antenna, such as a wireless communication unit, a memory 390, and one or more I/O device 350. Any other suitable assemblies, including but not limited to a system bus or a controller (not shown in the figure), may further be included in the mobile device 300. As shown in FIG. 3, a mobile operating system 370, such as an iOS, an Android, a Windows Phone, etc., and one or more applications 380 may be loaded in the memory 360 from the memory 390, and may be performed by the CPU 340. The application 380 may include a browser or another mobile application that is suitable for a receiving and processing microwave data or related information of an image analyzing on the mobile device 300. An interaction of relevant information about microwave data and image analysis between the user and one or more assemblies in the microwave identification system 100 may be obtained through the I/O device 350 and provided for the controller 120 and/or other assemblies in the microwave identification system 100. For example, through the controller or a communication module in other assemblies.

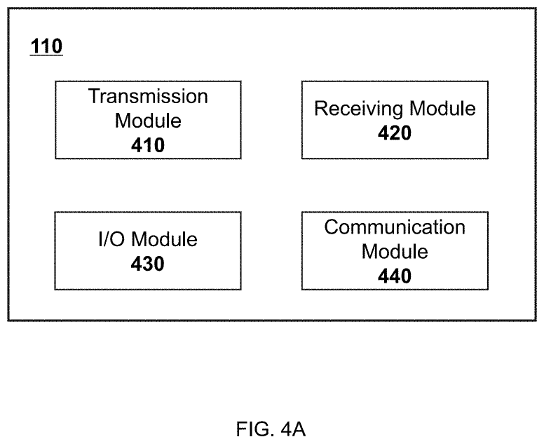

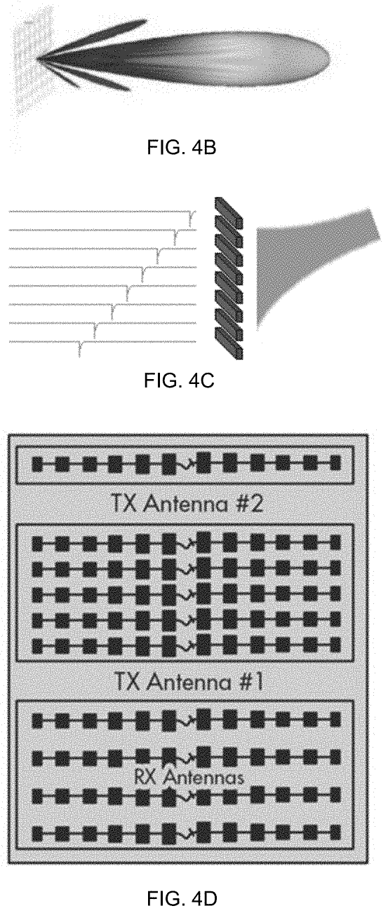

FIG. 4A is a module diagram illustrating a detector according to some embodiments of the present disclosure. The detector 110 may include a transmission module 410, a receiving module 420, an I/O module 430, and a communication module 440. The transmission module 410 may be configured to send a microwave signal to the surrounding environment. In some embodiments, the transmission module 410 may include a transmission circuit and a transmission antenna, the transmission circuit and the transmission antenna may be configured to transmit electromagnetic waves of various wavelengths. In some embodiments, through adjusting a power and/or voltage of the transmission circuit, the transmission antenna may transmit microwave signals of different bands or frequencies. For example, the microwave signal transmitted by the transmission antenna may be millimeter waves. In some embodiments, the antenna may use MIMO (Multi Input Multi Output) technology to increase a communication capacity and a spectrum utilization rate in times without increasing a bandwidth. In some embodiments, the antenna may further use a beam steering low sidelobe antenna technology (as shown in FIG. 4B) to inhibit a low side lobe whose side lobe level is below −30 dB, thereby achieving the opposition to all kinds of active interference beyond the main lobe to improve an anti-interference performance of the antenna. In some embodiments, the antenna may further use phased array main lobe narrow beam electronically controlled scanning technology (as shown in FIG. 4C), so as to quickly and accurately scan the object. The phased array antenna array may be an one-dimensional line array, a two-dimensional surface array (such as positive hexagonal array), a 3D array, etc. In some embodiments, the antenna may further adopt a high-gain 3D scanning for indoor short distance and large angle (e.g., scanning angle >120°), thereby achieving a large-scale, far-field scan, so as to achieve an overall monitoring and analysis on the object in the environment.

The receiving module 420 may be configured to obtain the microwave signal reflected back by objects in the surrounding environment. In some embodiments, the receiving module 420 may include a receiving circuit and a receiving antenna, the receiving circuit and the receiving antenna may be configured to receive electromagnetic waves of various wavelengths. In some embodiments, the microwave signal may be an analog signal or a digital signal. Exemplarily, the transmit and receiving pulse waveform of the antenna shown in FIG. 4D. The transmission module 410 includes a two-channel transmission antenna. The receiving module 420 includes a four-channel receiving antenna with adjustable baseband gain with low noise coefficient.

The receiving module 420 may adopt one or more pre-processing approaches to process the signal received and then send it to the controller 120 for continuous processing. The one or more pre-processing approaches include: a low-pass filtering, an A/D conversion, a pre-emphasis, a fast Fourier transform, etc. For example, the microwave signal received by the receiving module 420 may be an analog signal. The receiving module 420 may perform an A/D conversion on the analog signal and then send it to the controller 120.

In some embodiments, the microwave signal reflected by a static object may be a stable microwave waveform or a microwave waveform slightly changing over time, and the amplitude and frequency of the microwave signal reflected by a moving object may change with time. The microwave signal changes over time may be related to a moving status of the object (such as, a direction, a speed, or an acceleration, etc.). In some embodiments, the receiving module 420 may pre-process the obtained microwave signal, filter out a stable part or a part slightly changes over time in the microwave waveform, and send the part whose amplitude and/or frequency changes overtime to the controller 120 for further signal processing or logical judgment. As an example, the transmission module 410 and/or the receiving module 420 may be connected with a pre-processing circuit. The pre-processing circuit may be configured to process the pulse transmitted and/or the signal received. The pre-processing circuit includes one or more elements or sub circuits, such as a built-in phase locking loop (PLL), an FM continuous wave generator (FMCW), an ADC converter, a built-in temperature sensor, a built-in digital signal processing baseband SoC, etc.

The I/O module 430 may support the I/O data stream between the detector 110 and other assemblies (such as the receiving module 420) and between the detector 110 and other assemblies (such as the database 130) in the microwave identification system 100. In some embodiments, the detector 110 may obtain data from the user or other assemblies in the microwave identification system 100 through the I/O module 430. For example, the detector 110 may receive an instruction of adjusting a microwave transmission parameter issued by the user through the I/O module 430. For another example, the detector 110 may receive the instruction of adjusting a microwave transmission parameter issued by the controller 120 through the I/O module 430. Exemplarily, on the basis of a beamforming technology of the front-end antenna, through the I/O module 430, the controller 120 uses a beam management algorithm to adjust the microwave transmission parameter of the detector 110 to achieve a beam steering and beam tracking technology, and to control a beam direction to track the object to be detected intelligently. The controller 120 may further use a multipath interference cancellation algorithm and through the I/O module 430 to adjust the microwave transmission parameter of the detector 110 to achieve an interference and noise suppression. The controller 120 may further use an indoor static object elimination algorithm and through the I/O module 430 to adjust the microwave transmission parameter of the detector 110 to achieve a high-precision positioning and analysis of a moving object. In some embodiments, the detector 110 may transmit the data to other assemblies in the microwave identification system 100 through the I/O module 430. For example, the receiving module may directly transmit the signal received to the database 130 through the I/O module 430 after pre-processing.

The communication module 440 may establish a communication connection between the detector 110 and other assemblies (such as the controller 120) in the microwave identification system 100. A way of the communication may include a wired communication and a wireless communication. The wired communication may include communicating through a transmission medium such as a wire, a cable, an optical cable, a waveguide, a nanomaterial. The wireless communication may include an IEEE 802.11 series wireless LAN communication, an IEEE 802.15 series wireless communication (such as a Bluetooth, a ZigBee, etc.), a mobile communication (such as a TDMA, a CDMA, a WCDMA, a TD-SCDMA, a TD-LTE, a FDD-LTE, etc.), a satellite communication, a microwave communication, a scattering communication, a radio frequency communication, an infrared communication, etc. In some embodiments, the communication module 440 may use one or more encoding approaches to encode the transmitted information. The encoding approach may include a phase encoding, a non-return-to-zero code, a differential Manchester code, etc. In some embodiments, the communication module 440 may choose different transmission and encoding approaches according to the different types of data or networks that need to be transmitted. In some embodiments, the communication module 440 may include one or more communication interfaces, such as an RS485, an RS232, etc.

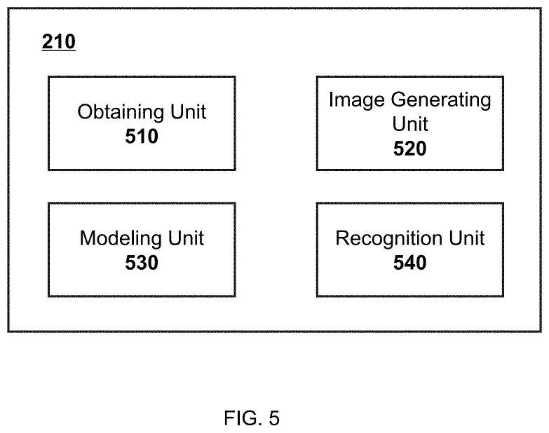

FIG. 5 is a schematic diagram illustrating a processing module according to some embodiments of the present disclosure. The processing module 210 may include an obtaining unit 510, an image generating unit 520, a modeling unit 530, and an identification unit 540.

The obtaining unit 510 may be used to obtain information collected by the detector 110. The obtaining unit 510 may perform communication connection with the one or more detectors 110 and obtain information transmitted by the detectors 110. In some embodiments, the information may be an unprocessed signal directly output from the detector 110. The signal may include a microwave signal. In some embodiments, the information may be generated after a pre-processing by the detector 110. For example, the microwave signal obtained by the detector 110 may be a time domain signal. The detector 110 may transform the time domain signal into a frequency domain signal and obtain the frequency domain signal, and the detector may filter out fixed frequency element information in the frequency domain signal. The frequency domain signal after the pre-processing may be output to the obtaining unit 510.

The image generating unit 520 may be configured to generate an image of one or more objects in the surrounding environment. In some embodiments, the image generating unit 520 may generate an image according to the microwave signal obtained by the obtaining unit 510. The microwave imaging approach may include a synthetic aperture radar imaging, an inverse synthetic aperture radar imaging, a radio camera or real aperture radar imaging, etc. In some embodiments, the image generating unit may obtain the image after processing the microwave signal detected by the inverse synthetic aperture radar through one or more types of imaging algorithms. The one or more imaging algorithms may include a two-dimensional FFT imaging approach, a spherical wave focusing convolution imaging approach, a filter-back projection (B-P) imaging approach, a range-Doppler imaging approach, etc. For example, the image generating unit 520 may be processed by the microwave signal obtained by the obtained unit 510 through the range-Doppler imaging method. In some embodiments, the image may be a dynamic image or a plurality of images at different time instants. For example, the image may include a plurality of images collected within a certain period of time.

The modeling unit 530 may be configured to generate a model of each of one or more objects. In some embodiments, the modeling unit 530 may obtain feature data of one or more objects from the image generating unit 520 or one or more storage units, and build a model of the corresponding object based on the feature data. A modeling process of the modeling unit 530 may include a 2D modeling and a 3D modeling. For example, the modeling unit 530 may extract a plurality of 2D images from different perspectives of a target object, extract feature points in the plurality of 2D images, match the feature points, eliminate bad matching points, perform camera self-calibration, calculate the 3D coordinates of the feature point, and construct a 3D space model of the target object. In some embodiments, the modeling unit 530 may construct a model through one or more modeling approaches, the one or more modeling approaches may include a radar cross section (RCS) modeling approach, a simple geometric body combination model approach, a panel model approach, a parameter surface model approach, etc. In some embodiments, the model generated by the modeling unit 530 may be stored in the database 130.

The identification unit 540 may be used to identify one or more objects in the image. The identification unit 540 may extract one or more features in the image and compare the one or more features of the image with the features corresponding to a plurality of models generated by the modeling unit 530. Based on a result of the comparison, the identification unit 540 may identify the objects in the image. The one or more features in the image may include a contour, a shape, or a size. For example, the identification unit 540 may extract the contour feature in the image, and make a one-to-one comparison with the contour features of the plurality of models generated by the modeling unit 530. When the contour feature in the image consists with a certain person model, the identification unit 540 may identify the object in the image as a human body. For another example, the identification unit 540 may perform an effective identification on a moving person, a moving pet, and other objects (such as a fan, a sweeping robot, etc.) based on a range-Doppler 2D millimeter wave imaging and the Fourier analysis algorithm and the autocorrelation entropy algorithm. At the same time, the indoor target static objects (e.g., walls, plants, decorations, etc.) may be scanned and detected to achieve a function of adaptive electronic fence. For another example, the identification unit 540 may identify a machine learning KNN and PCA algorithms based on the binarization adaptive mean filtering to achieve a multi-posture detection of the human body. For another example, the identification unit 540 may perform a motion tracking on a multi-target speed and ranging based on the target aggregation algorithm, the target detection algorithm, the time difference positioning algorithm, and the phase comparative positioning algorithm, and through the Kalman filtering, thereby achieving an accurate positioning of multi-target human body and a posture identification of multi-target human body. For another example, the identification unit 540 may further identify the algorithm and a probabilistic neural network (PNN) machine learning algorithm based on the Bayesian model, and perform a short-time Fourier transform (STFT) in time-frequency domain and Chirplet decomposition algorithm on a step length, a gait frequency and/or a gait phase to identify a gait of the target human body (such as different gaits of different family members) through a learning analysis on the gaits of a plurality of different human bodies, thereby accurately identifying the family members. In some embodiments, the identification unit 540 may generate alarm information after determining that the object in the image is the human body that enters the electronic fence and is not a family member. The alarm information may be sent to the alarm 140, a user, a security agency, a police station, etc. through the I/O module 430. The alarm information may include a control instruction that controls a start of the alarm 140, notification information transmitted to the terminal device 160, and basic information of the invader sent to the security agency or the police station, etc. For example, the alarm 140 may issue an alarm warning after receiving the control instruction. In some embodiments, the alarm 140 may perform an alarm warning in a form of whistle and flashing according to the instruction. For example, when the identification unit 540 identifies that the object in the image is the human body that enters the electronic fence and is not a family member, a control instruction may be generated and transmitted to the alarm 140, the alarm 140 may turn on an alarm horn to warn after receiving the control instruction.

In some embodiments, the image generating unit 520, the modeling unit 530, and/or the identification unit 540 may include a machine learning sub-unit. In some embodiments, the machine learning sub-unit may be implemented by a FPGA-based machine learning algorithm chip. The machine learning sub-unit may contain one or more functional parts. The functional parts may include a Bayes Classifier, a PCA (Principle Component Analysis), a K-Nearest Neighbor, a linear discriminant analysis, a Gaussian mixture model, a probabilistic neural network PNN, etc. The machine learning sub-unit may be trained by entering a training sample and a training parameter, and may be used to generate an image of the detected object, to establish a model of the plurality of objects, and/or to identify the detected object.

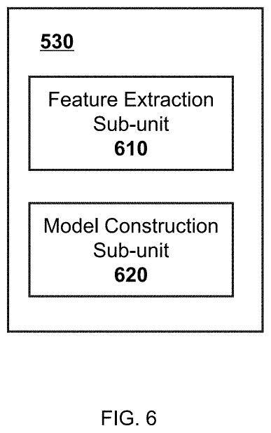

FIG. 6 is a schematic diagram illustrating a modeling unit according to some embodiments of the present disclosure. The modeling unit 530 may include a feature extraction sub-unit 610 and a model construction sub-unit 620. The feature extraction sub-unit 610 may be configured to obtain an image of one or more specific objects (at least one static image or dynamic image collected at different time instants, such as a video), and extract one or more features from the image. The features may include a contour, a shape, an edge, a texture, a size, a moving speed, a moving frequency, a motion displacement, etc. The moving frequency may include a moving frequency of a human body (for example, a torso swing frequency, a heart rate, a breathing rate, a pulse rate, etc.) and/or the moving frequency of a static object (such as a rotation frequency of a fan blade, a swing frequency of a pendulum). The motion displacement may be the displacement of one or more specific objects between two different moments corresponding to any two different static images respectively, or the displacement of one or more specific objects between two different moments corresponding to any two different images of the dynamic image, respectively. The moving speed may be an average speed. For example, the moving speed may be a quotient of the motion displacement and the difference between the corresponding two moments, that is, the average speed between the two time instants. The feature extraction sub-unit 610 may extract the features in the image through one or more approaches for extracting image features. The one or more approaches for extracting image features may include a principal component analysis (PCA) approach, a Fisher linear distinguish (FLD), a projection pursuit (PP), a linear determination analysis (LDA) approach, a multi-dimensional scale (MDS) approach, a support vector machine (SVM), a key principal component analysis (KPCA) approach, a key Fisher determination approach (KFLD), a stream-based learning approach, etc. In some embodiments, the image of the specific object may be generated by the microwave identification system 100 according to the obtained microwave data of the specific object. In some embodiments, the feature extraction sub-unit 610 may obtain the image of one or more specific objects from the image generating unit 520 or one or more storage units, and extract the feature point of the specific objects from the image. The feature points may be used to construct the model of the object. For example, the feature extraction sub-unit 610 may extract a plurality of 2D images from different perspectives of a target object from the image generating unit 520 and extract the feature point in the 2D image.

The model construction sub-unit 620 may be configured to construct a model of each of the one or more objects according to the one or more features. The model construction sub-unit 620 may construct the model of the corresponding object according to the features extracted by the feature extraction sub-unit 610. The model of the object may include a 2D model, a 3D model, etc. For example, the model construction sub-unit 620 may match the feature points of the 2D image of different perspectives of the target object extracted by the feature extraction sub-unit 610, and eliminate bad feature points, then on the feature point of the target objects extracted by the feature extraction sub-unit 610 to match the feature points of the 2D image of the perspective and eliminate the bad matching points, perform camera self-calibration, calculate the 3D coordinates of the feature point, and construct a 3D space model of the target object. In some embodiments, the model construction sub-unit 620 may construct the model through one or more modeling approaches, the one or more modeling approaches may include a radar cross section (RCS) modeling approach, a simple geometric body combination model approach, a panel model approach, a parameter surface model approach.

For example, based on a dynamic image or a plurality of static images collected at different time instants, the feature extraction sub-unit 610 may identify and extract one or more features of a heart, such as a micro-motion parameter of the heartbeat, and then construct a human body heart model through the model construction sub-unit 620. Based on a micro-Doppler fast Fourier transform, a Gaussian filter algorithm, and the autocorrelation entropy algorithm, the detection of the static human body and the human physiological parameter (such as the heart rate) monitoring may be implemented. For another example, based on at least one posture in the moving process of the human body, the feature extraction sub-unit 610 may identify and extract one or more features of each posture. For example, when a person is standing, he may stand upright and still with hands drooping naturally. For another example, when the person is marching, he may walk uniformly or non-uniformly, with hands swinging naturally. Based on the one or more features of each posture, through the model construction sub-unit 620, a model of the human body with different postures may be constructed. A multi-posture detection of the human body may be implemented based on the binarization adaptive mean filtering, the approach identification machine learning KNN algorithm, and the PCA algorithm.

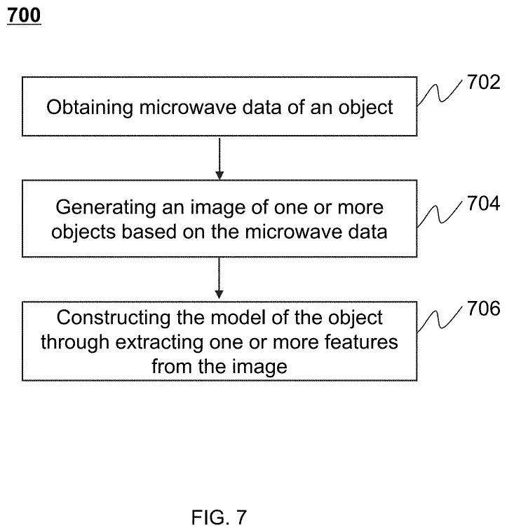

FIG. 7 is a schematic flowchart illustrating construction of a specific object model according to some embodiments of the present disclosure. In some embodiments, the process 700 may be implemented by at least one device. The at least one device may include at least one processor and at least one storage device. Operations 702 to 706 may be stored in the at least one storage device in the form of computer programs. When the at least one processor executes the computer programs, the approach in the process 700 may be implemented. In 702, the controller 120 may obtain microwave data of an object. The object may be a known object, such as a human body, an animal, a household appliance, etc. The microwave data may be derived from a microwave signal, and the microwave signal may be reflected back by a moving object. The microwave signal may be obtained by the detector 110, and the microwave data may be provided to the controller 120 by the detector 110. The microwave data may include at least one of a wavelength, an amplitude, a frequency, a phase, etc., of the microwave signal. The microwave data obtained by the controller 120 may be the microwave signal directly obtained by the detectors 110, or the microwave data generated after the microwave signal is pre-processed by the detectors 110. The microwave data may be centimeter wave microwave data, millimeter wave microwave data, etc. In some embodiments, the microwave data may be the millimeter wave microwave data.

In 704, the controller 120 may generate an image of the object based on the microwave data. The image may be a static image (one image or a plurality of images collected at different time instants) or a dynamic image, such as a video. The controller 120 may further process the microwave signal obtained using one or more approaches. The one or more approaches may include a fitting, an interpolation, a dissociation, an A/D conversion, a Z transform, a wavelet transform, a Fourier transform, a feature extraction, a low pass filtering, a fast Fourier transform, a binarization adaptive mean filtering, a Gaussian filtering, a Kalman filtering noise reduction processing, a dark current processing, a moving target identification, an image segmentation, an image enhancement, an image reconstruction, a non-uniformity correction, a target condensation algorithm, a target detection algorithm, a time difference positioning algorithm, a phase comparison positioning algorithm, etc. In some embodiments, the image may be a 2D image which includes one or more points, and each point may represent a scattering source. The scattering source may include a mirror scattering source, an edge scattering center, a spire scattering center, a concave cavity, a row wave and peristaltic wave loaded scattering. The image may reflect a spatial distribution of the scattering source. In some embodiments, the microwave signal may be synthesized by a scattering of one or more scattering sources. The distribution of the scattering source may be determined by the microwave signal to construct the image of the object. The image may be obtained according to one or more imaging algorithms according to the microwave data. The one or more imaging algorithms may include a 2D FFT algorithm, a spherical wave focused convolution algorithm, a filter back-projection (B-P) algorithm, a range-Doppler imaging algorithm, etc.

In 706, the controller 120 may construct the model of the object through extracting one or more features from the image. The features may include a contour, a shape, an edge, a texture, a size, a moving speed, a moving frequency, a motion displacement, etc. The controller 120 may extract the features of the image through one or more approaches of extracting the image feature. The one or more approaches of extracting the image feature include a principal component analysis (PCA) approach, a Fisher linear distinguish (FLD), a projection pursuit (PP), a linear determination analysis (LDA) approach, a multi-dimensional scale (MDS) approach, a support vector machine (SVM), a key principal component analysis (KPCA) approach, a key Fisher determination approach (KFLD), a stream-based learning approach, etc. The feature may be used to construct an object model to identify an object in a given image. In some embodiments, the controller 120 may use the RCS model construction approach to construct an object model.

For example, based on a dynamic image or a plurality of static images collected at different time instants of the human body, the controller 120 may identify and extract one or more features of the hear, such as a micro-motion parameter of the heartbeat, and then construct a human heart model. Based on the micro-Doppler fast Fourier transform and the Gaussian filter algorithm and the autocorrelation entropy algorithm, a detection of static human body, and a human physiological parameters (such as a heart rate) monitoring may be implemented. For another example, the controller 120 may identify and extract one or more features of each posture based on changes of the posture in a moving process of the human body. For example, when a person is standing, he may stand upright and still with hands drooping naturally. For another example, when the person is marching, he may walk uniformly or non-uniformly, with hands swinging naturally. Based on the one or more features of each posture, the controller 1220 may construct a model of the human body with different postures. A multi-posture detection of the human body may be implemented based on the binarization adaptive mean filtering, the approach identification machine learning KNN algorithm, and the PCA algorithm.

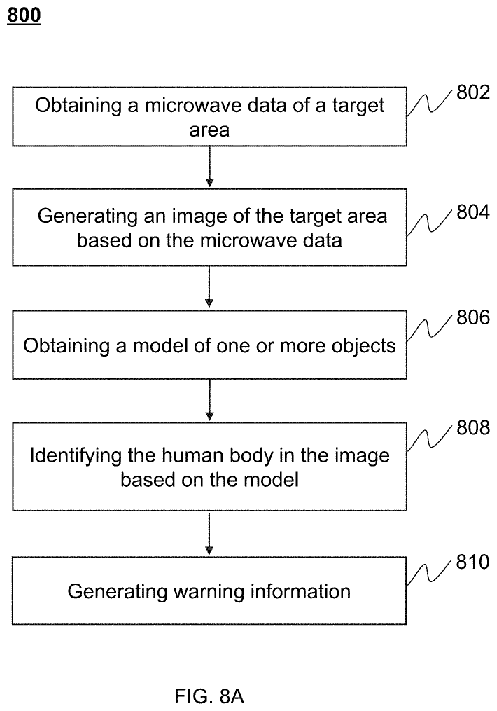

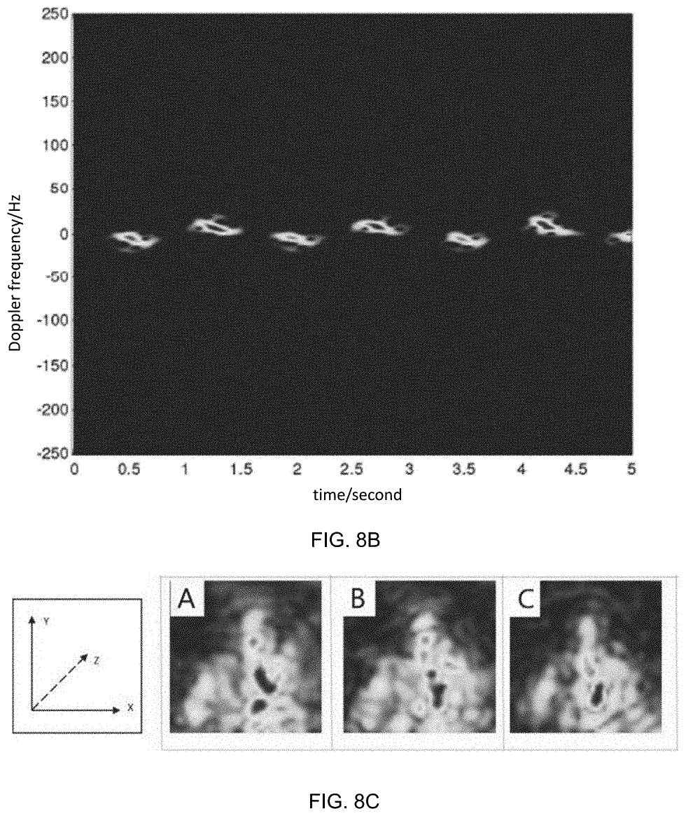

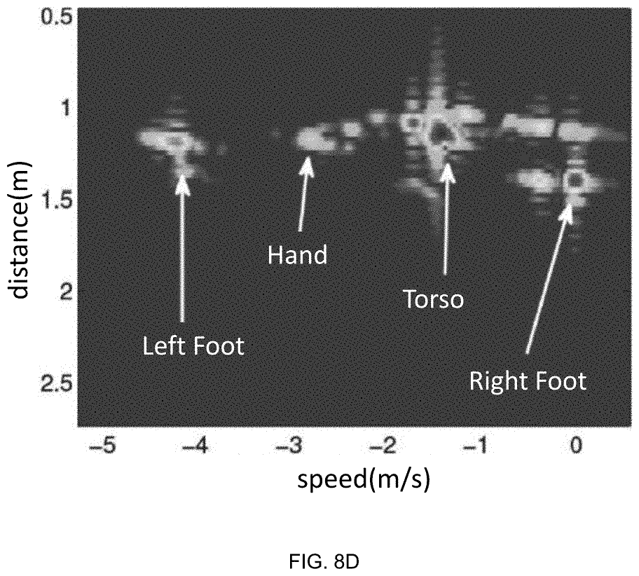

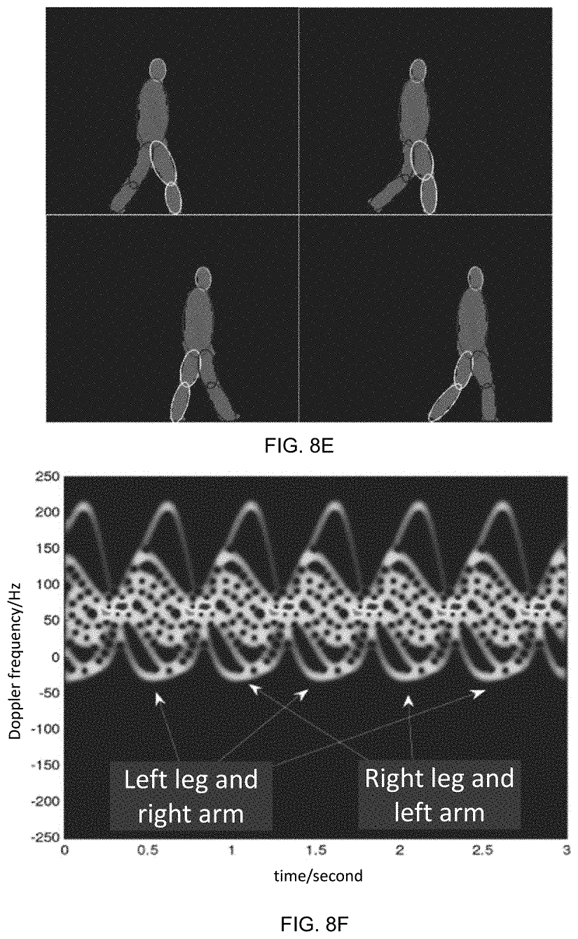

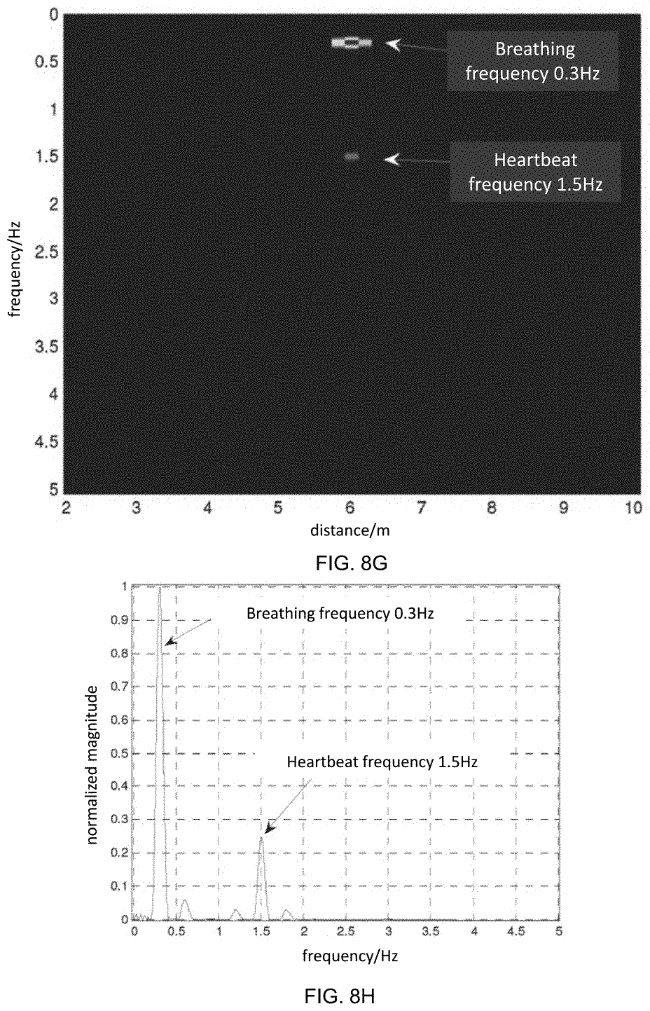

FIG. 8A is a schematic flowchart illustrating a microwave signal identification system according to some embodiments of the present disclosure. Operation 802 may include obtaining microwave data of a target area through the detector 110, the microwave data may be derived from a microwave signal, the microwave signal may be derived from a signal reflected by one or more objects in the target area. The microwave signal may be obtained by one or more detectors 110, and the microwave data may be provided to the controller 120. The microwave data may include at least one of a wavelength, an amplitude, a frequency, a phase, etc. of the microwave signal. In some embodiments, the microwave data may be millimeter wave microwave data. In some embodiments, the operations in 802 may be the same or similar to that in operation 702 in FIG. 7.

In 804, the controller 120 may generate an image of the target area based on the microwave data. The image may be a static image or a dynamic image, such as a video. The microwave data includes at least one of the waveform, the wavelength, the amplitude, the frequency, the phase, etc. of the microwave signal. The image may be a 2D image of one or more objects in the target area. The image of each object may include one or more points, and each point may represent a scattering source. The scattering sources may include one or more of a mirror scattering source, an edge scattering center, a spire scattering center, a concave cavity, a row wave and peristaltic wave loaded scattering. The image of the object may reflect a spatial distribution of the scattering source. The microwave signal reflected back by each object may be synthesized by a scattering of one or more scattering sources. The controller 120 may speculate the distribution of the scattering source through the microwave signal to construct an image of the corresponding object. The image may be obtained through performing one or more imaging algorithms on the microwave data. The one or more imaging algorithms may include a 2D FFT algorithm, a spherical wave focused convolution algorithm, a filter back-projection (B-P) algorithm, a range-Doppler imaging algorithm, etc. For example, in the night, the controller 120 may process the received microwave signal through the filter back-projection (B-P) algorithm to obtain a 2D image of the target object. Exemplarily, FIG. 8B is an image of a pet dog in a plurality of moments generated based on microwave data according to some embodiments of the present disclosure. FIG. 8C is three human body images generated based on the microwave data according to some embodiments of the present disclosure. In 806, the controller 120 may obtain a model of each of one or more objects. The controller 120 may construct a model of the object based on one or more modeling approaches. The one or more modeling approaches may include a radar cross section (RCS) modeling approach, a simple geometric body combination model approach, a panel model approach, a parameter surface model approach, etc. The model constructed by the controller 120 may be stored in the database 130, and the controller 120 may send a transfer instruction to the database 130 to obtain the model. For example, the controller 120 may obtain a plurality of models in the database. By performing one-to-one comparison between the feature of the image and the features of the plurality of models, the controller 120 may identify the object in the image based on the result of the comparison.

In 808, the controller 120 may identify the human body in the image based on the model. The controller 120 may use one or more approaches for extracting image feature to extract one or more features of the image and extract corresponding feature of the plurality of models. The one or more features may include at least one of a contour, a shape, a size, a texture, a moving speed, a moving frequency, a movement displacement, a feature point distribution, etc. The one or more approaches for extracting image feature may include a principal component analysis (PCA) approach, a Fisher linear distinguish (FLD), a projection pursuit (PP), a linear determination analysis (LDA) approach, a multi-dimensional scale (MDS) approach, a support vector machine (SVM), a key principal component analysis (KPCA) approach, a key Fisher determination approach (KFLD), a stream-based learning approach, etc. The controller 120 may perform a one-to-one comparison between the feature of the image and the features of the plurality of models, and identify the object or the human body in the image. For example, the controller 120 may compare the contour feature of the image extracted with the contour feature of each model. When the contour feature of the image is consistent with the contour of a human model, the controller 120 may determine that the object in the image is the human body. For another example, when the feature of the object in the dynamic image is consistent or roughly consistent with the feature of a human moving model (such as a human walking model), the controller 120 may determine that the object in the image is a human body and the person is walking based on the binarization adaptive mean filtering, the approach identification machine learning KNN algorithm, and the PCA algorithm.

In some embodiments, when the controller 120 is identifying the human body or another object in the image generated, the controller 120 may process the image generated in operation 840. For example, the processing may include the Fourier analysis algorithm and the autocorrelation entropy algorithm. Based on the model of the corresponding human body or another object (such as a moving human model, a moving object model, a moving pet model, a target static object model, etc.), and the processed image, an effectively identification may be performed on the moving human body, the moving object, and the moving pet. At the same time, the indoor target static objects (e.g., walls, plants, decorations, etc.) may be scanned and detected to achieve a function of adaptive electronic fence. For another example, when identifying the human body in the image, the processing may be based on the binarization adaptive mean filtering, the approach identification machine learning KNN algorithm, and the PCA algorithm. For example, the human posture learning analysis in FIG. 8D, wherein a human torso, hands, left and right feet may be identified. The torso, the hands, the left foot, and the right feet may have different speeds when collected. Based on the model of the corresponding human body or another object (such as the model of at least one posture of the human body) and the processed image, the multi-posture detection of the human body (walking, sitting, squatting, lying, falling, etc.) may be realized, or the processing may include target aggregation algorithm, the target detection algorithm, the time difference positioning algorithm, and the phase comparative positioning algorithm, and through the Kalman filtering. Based on the model of corresponding human or the other object (such as the model of the human body and the model of at least one posture of the human body) and the processed image, a motion tracking on a multi-target speed and ranging may be performed, to achieve an accurate positioning of multi-target human body and a posture identification of multi-target human body. For another example, the processing may include the Bayesian approach identification algorithm and the probabilistic neural network (PNN) machine learning algorithm, and a short-time Fourier transform (STFT) in time-frequency domain and Chirplet decomposition algorithm may be performed on a step length, a gait frequency, and a gait phase of the human body. For example, the gait learning analysis of the human body in FIG. 8E and FIG. 8F, wherein a left arm, a right arm, a left leg and a right leg may be identified based on the corresponding model of the human body or another object (such as at least one target gait model of the human body) and the processed image to realize the gait learning analysis of a plurality of different human bodies (the gait learning analysis of the family members), based on the model of the corresponding human body and other objects as well as the processed image, the gait of the target human body may be identified, thereby distinguish the different gait of each family member and realizing the identification of different family members. For another example, the processing may include a micro-Doppler cross-correlation entropy algorithm and the Karman filter algorithm, such as the heart rate and breathing analysis of the human body in FIG. 8G and FIG. 8H, a heartbeat frequency may be 0.3 Hz, and a breath frequency may be 1.5 Hz. Based on the model of the corresponding human body and other objects (such as a physiological parameter model) as well as the processed image, a far-field human blood pressure measurement may be performed on the arteries and veins of the human body, thereby realizing the monitoring of the physical condition of the elderly in a smart elderly support scenario. For a normal human body, an aorta diastolic flow is about 40 cm/s, an aorta systolic flow is about 50 cm/s, and a veiny flow is about 30 cm/s.

In some embodiments, the model of the human body or another object, the model of at least one posture of the human body, the model of at least one target human gait, the model of the physiological parameter, etc., may be implemented by one or more comprehensive models. Each comprehensive model may contain one or more of the models of the human body or another object, the model of at least one posture of the human body, the model of at least one target human gait, the model of the physiological parameter, etc.

In some embodiments, the model of the human body or another object, the model of at least one posture of the human body, the model of at least one target human gait, the model of the physiological parameter, etc., or a comprehensive model may be an available model, or may be a model to be trained. A training may be performed individually for each model, or may be performed on all models at the same time. The model of the human body or another object, the model of at least one posture of the human body, the model of at least one target human gait, the model of the physiological parameter, etc., or a comprehensive model may be constructed according to the process 700 shown in FIG. 7.

In step 810, the controller 120 may generate alarm information. The controller 120 may identify the object or the human body in the image, and may further determine whether the object or the human body is a specific object or the human body (such as whether the human body is a family member, whether the object is a home pet, etc.). In response to the determining that the object or the human body in the image belongs to a specific object or human body, the controller 120 may decide that the specific object or the human body is an invader, and the alarm information may be generated. The alarm information may include a control instruction to control the alarm to start, notification information transmitted to the terminal device 160, etc. The alarm 140 may issue an alarm warning after receiving the control instruction. In some embodiments, the alarm 140 may make an alarm warning in the form of whistle and flashing, such as turning on an alarm flashing light, an alarm speaker, and a buzzer, etc. For example, when the controller 120 identifies that the object in the surrounding environment is not a human body in the model, the controller 120 may generate the control instruction and transmit the control instruction to the alarm, the alarm 140 may turn on an alarm horn to warn after receiving the control instruction.

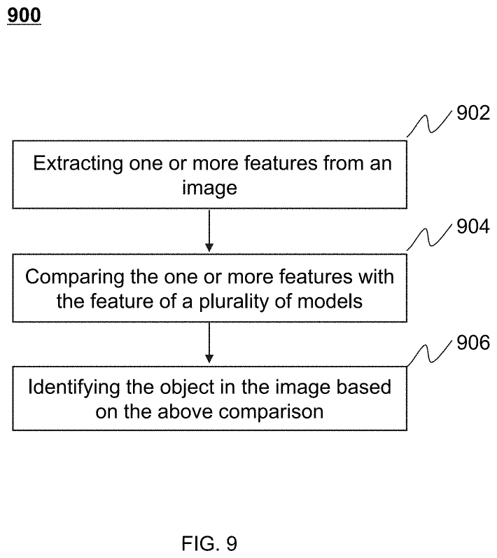

FIG. 9 is a schematic flowchart illustrating an object identification based on a model according to some embodiments of the present disclosure. In 902, the controller 120 may extract one or more features from an image according to one or more approaches of extracting an image feature. The features may include one or more of a contour feature, a regional feature, a texture feature, a grayscale feature, etc. In some embodiments, the features may include a contour, a shape, an edge, a texture, a size, etc. The one or more approaches of extracting the image feature may include a principal component analysis (PCA) approach, a Fisher linear distinguish (FLD), a projection pursuit (PP), a linear determination analysis (LDA) approach, a multi-dimensional scale (MDS) approach, a support vector machine (SVM), a key principal component analysis (KPCA) approach, a key Fisher determination approach (KFLD), a stream-based learning approach, etc. In some embodiments, the operation 902 may further include performing an image pre-processing and an image segmentation on the image before extracting the image feature. The image pre-processing may eliminate irrelevant information in the image, enhance a detectability of the relevant information and simplify the data to the greatest extent. An approach for image pre-processing may include a panoramic distortion correction, a warping correction, a false color enhancement, a histogram enhancement, a subtraction processing, a Fourier back projection, a convolution back projection, etc. The image segmentation may divide the image into a series of non-overlapping areas, thereby extracting a target object. An approach for image segmentation may include a region-based segmentation and a morphological watershed-based segmentation. For example, the controller 120 may extract the target object in the image through performing the warping correction and the image segmentation on the image, and may obtain the contour feature of the target object through the image feature extraction approach.

In 904, the controller 120 may compare the one or more features with the feature of a plurality of models. The controller 120 may obtain a description parameter of the feature obtained when extracting the feature. The feature extracted may include one or more of a contour feature, a regional feature, a texture feature, a grayscale feature, a moving feature, etc. In some embodiments, the description parameter of the contour feature may include a diameter of the contour, a length of the contour, a slope, a curvature, an angle point, etc. In some embodiments, the description parameter of the regional feature may include a regional area, a regional center of gravity, or a shape feature of the region. In some embodiments, the description parameter of the texture feature may include a size of a texture primitive and the law of the texture primitive. In some embodiments, the description parameter of the grayscale feature may include a transmittance, an optical density, and an integrated optical density. In some embodiments, the description parameter of the moving feature may include a moving speed, a moving direction, a moving frequency, a motion displacement, etc. The controller 120 may compare the description parameter of the feature in the image with the description parameter of the feature of the plurality of models. For example, the controller 120 may obtain the length, the slope, the curvature, and the angle point of the contour through extracting the contour feature of the target object, and may perform a one-to-one comparison between the length, the slope, the curvature, and the angle point of the contour of the target object with that of the contour of the model.

In 906, the controller 120 may identify the object in the image based on the above comparison. The controller 120 may match the plurality of models in the database 130 with the image. The models in the database 130 may include a rotating fan, a shaking plant, a pet at home, an owner of the house, etc. In some embodiments, the matching of the picture and the model may be implemented by comparing the description parameter of the feature. When the description parameter of the image feature consists with the feature parameter of a model, the match may be successful. When the description parameter of the image feature is different from a model, then the match may fail. A successful match may determine that the object in the image is an invading object, and a failed match may determine that the object in the image is not an invading object. For example, the controller 120 may compare the description parameter of the contour of the object in the image with the description parameter of the contour of the model. When the description parameter of the contour of the object in the image is inconsistent with the description parameter of the contour of the human body in the model, the controller 120 may determine that the object is not an invading object.

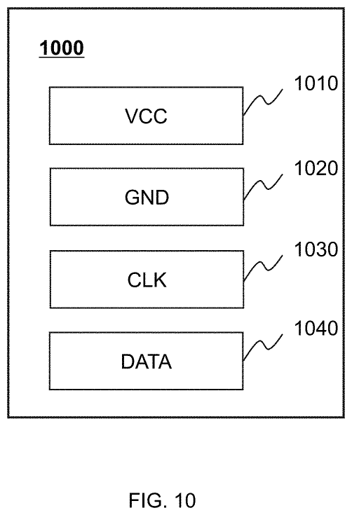

FIG. 10 is a schematic diagram illustrating a circuit connection according to some embodiments of the present disclosure. A connection circuit 1000 may be a connection circuit of the controller 120 or the detector 110. The connection circuit 1000 may include one or more VCC pins 1010, GND (ground) pins 1020, CLK (clock) pins 1030 and DATA pins 1040. The VCC pin 1010 may be connected with a positive electrode of a power supply to maintain a high potential. In some embodiments, the VCC pin of the controller 120 may be connected with the VCC pin of the detector 110, and the controller 120 may provide a high potential for the detector 110 through the connection between the VCC pins. The VCC pin of the detector 110 may obtain a high potential through the connection with the VCC pin of the controller 120. The GND pin 1020 may be connected with the ground to maintain a neutral potential.

In some embodiments, the CLK pin of the controller 120 may generate a clock signal to control the connection between the controller 120 and the detector 110. The CLK pin of the detector 110 may receive the clock signal from the controller 120. The DATA pin 1040 of the controller 120 may transmit information to the detector 110, or receive information from the detector 110. The DATA pin 1040 of the detector 110 may transmit information to the controller 120, or receive information from the controller 120. For example, the control instruction issued by the controller 120.

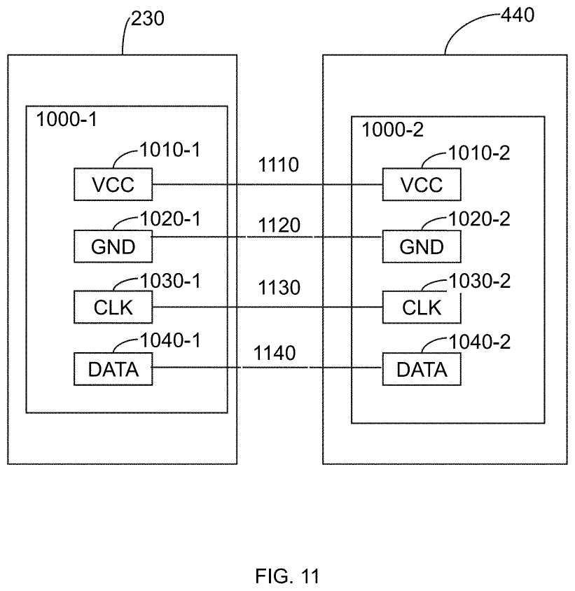

FIG. 11 is a schematic diagram illustrating the connection circuit between a controller and the detector according to some embodiments of the present disclosure. The controller 120 and the detector 110 may perform data and information transmission through a communication module, and a communication module 230 of the controller 120 and a communication module 440 of the detector 110 may be electrically connected. A VCC pin 1010-1 of the communication module 230 of the controller 120 and the VCC pin 1010-2 of the communication module 440 of the detector 110 may be connected through a first wired circuit 1110 to enable the communication module 230 of the controller 120 have the same potential with the communication module 440 of the detector 110. A GND pin 1020-1 of the communication module 230 of the controller 120 and a GND pin 1020-2 of the communication module 440 of the detector 110 may be connected through a second wired circuit 1120. In some embodiments, the GND pin 1020-1 of the communication module 230 of the controller 120 may be connected with the ground, so that the GND pin 1020-1 of the communication module 230 of the controller 120 and the GND pin 1020-2 of the communication module 440 of the detector 110 may keep may remain neutral. In some embodiments, the first wired circuit 1110 and the second wired circuit 1120 may be a same wire. A CLK pin 1030-1 of the communication module 230 of the controller 120 and a CLK pin 1030-2 of the detector 110 may be connected through a third wired circuit 1130. The communication module 440 of the detector 110 may receive a clock signal through the third wired circuit 1130. In some embodiments, the clock signal may be generated by the processing module 210 of the controller 120. In some embodiments, the communication module 440 of the detector 110 may perform operations like starting, restoring, resetting, and synchronizing with the communication module 230 of the controller 120, etc. based on the clock signal received. A DATA pin 1040-1 of the communication module 230 of the controller 120 and a DATA pin 1040-2 of the communication module 440 of the detector 110 may be connected through a fourth wired circuit 1140. The fourth wired circuit 1140 may perform information transmission. In some embodiments, the information may be transmitted from the communication module 230 of the controller 120 to the communication module 440 of the detector 110, or the information may be transmitted from the communication module 440 of the detector 110 to the communication module 230 of the controller 120.

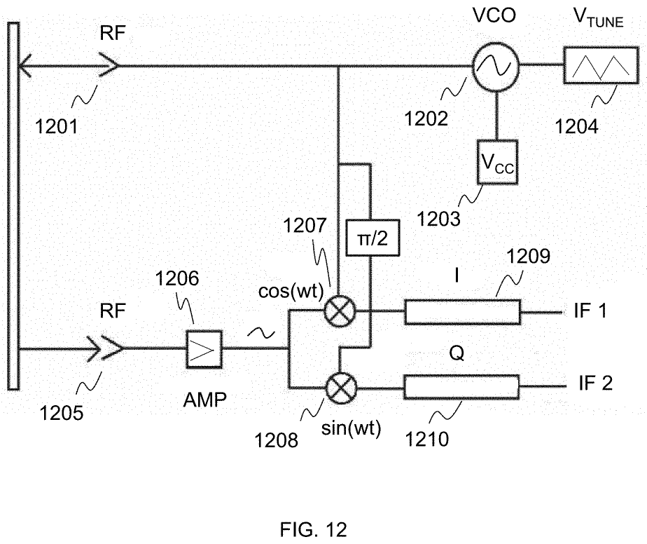

FIG. 12 is a schematic diagram illustrating a circuit configuration of a microwave radar according to some embodiments of the present disclosure. When the microwave radar is working, a modem 1204 emits a voltage signal. After the voltage signal is input to a voltage-controlled oscillator 1202, the voltage-controlled oscillator 1202 may issue a transmit signal with a frequency f. A working voltage of the oscillator may be provided by a power supply 1203. One channel of the transmission signal may be transmitted through a transmitting antenna 1201, and the other channel of the transmission signal may be divided into two channels and enter a mixer 1207 of the I channel and the mixer 1208 of the Q channel respectively. The signal divided into the Q channel needs to be phase-shifted by 90 degrees before mixing. A receiving antenna 1205 may be configured to receive an echo signal. The echo signal may first be processed by a low noise amplifier 1206, then be respectively mixed with the two signals divided into the mixer 1207 of the I channel and the mixer 1208 of the Q channel. The mixed signal in the I channel may be amplified through a first intermediate frequency (IF) filter 1209 to obtain an I signal. The mixed signal in the Q channel may be amplified through a second IF filter 1210 to obtain a Q signal. The I signal and the Q signal may have relevant information on the frequency, the amplitude, and the phase position. An effective RCS of the microwave radar may be measured according to a returned power of the incident waves. The effective scattering cross section RCS is a function of a function of an azimuth, a frequency, a transmit and receive antenna polarization features, etc. A scattering field the function measures may be caused by a re-radiation of a current induced by the incident waves on the scattering source. In some embodiments, first based on an equivalence principle, the scattering field of an original target may be decomposed into a superposition of an electrically large target scattering field and a detail electric small size scattering field. The electrically large target scattering field may be calculated by a physical optical method, and the detail electric small size scattering field may be calculated with the help of a moment method, etc. Then the respective scattering field may be superimposed. An RCS modeling and a 2D imaging of the target may use a broadband signal technique to obtain a high resolution of a target scattering sources at a radial distance, and may use a Doppler information of the moving target to obtain a high resolution of the scattering source at a horizontal distance. The 2D imaging of the target may be obtained using a range-Doppler imaging principle and according to a working approach of an ISAR radar.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Some embodiments use numbers describing ingredients and attributes. It should be understood that this kind of number used by the embodiment is modified by words like “approximately”, “approximate” or “generally”. Unless otherwise stated, “approximately”, “approximate” or “generally” indicates that the number of numbers allows ±20% of changes. Correspondingly, in some embodiments, the value parameters used in the manual and claims are similar values. The approximate value may be changed according to the features of individual embodiments. In some embodiments, the numerical parameters should consider the effective digits specified and use the method of general digits. Although the numerical domains and parameters that are used in some embodiments to confirm the range of the range are approximate values, in specific embodiments, the setting of such values is as accurate as possible within the feasible range.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A method for microwave identification, implemented on at least one device including at least one processor and at least one storage device, the method comprising:
obtaining, by the at least one processor, microwave data;
generating, by the at least one processor, an image of one or more objects based on the microwave data;
obtaining, by the at least one processor, a model of each of one or more objects; and
identifying, by the at least one processor, the one or more objects in the image of the one or more objects based on the model for one or more objects.

2. The method of claim 1, wherein the model of each of the one or more objects is determined according to a radar cross section (RCS) model construction approach, the method comprising:
obtaining an image of one of the one or more objects and extracting one or more features from the image of the object; and
constructing the model of the object based on the one or more features.

3. The method of claim 1 or 2, wherein the image is a two-dimensional (2D) image that includes one or more points, and each of the one or more points represents a scattering source.

4. The method of claim 1, wherein the microwave data is obtained through one or more microwave radars, microwaves emitted by the one or more microwave radars are millimeter waves.

5. The method of claim 1, further comprising:
performing a preprocessing on the microwave data obtained by the at least one processor.

6. The method of claim 5, wherein the preprocessing includes at least one of an analog to digital (A/D) conversion, a Fourier transform, a noise reduction processing, or a dark current processing.

7. The method of claim 1, wherein the identifying the one or more objects in the image of the one or more objects based on the model for each of the one or more objects comprises:
extracting one or more features from the image;
comparing the one or more features with a feature of the model for each of the one or more objects; and
identifying, based on the comparison, the one or more objects in the image.

8. The method of claim 7, further comprising:
determining that the one or more objects in the image is a human body;
generating warning information in response to determining that the one or more objects in the image includes a human body.

9. The method of claim 7, wherein the one or more features include at least one of a contour, a shape, a size, a texture, a moving speed, a moving frequency, or a moving displacement.

10. The method of claim 1, wherein the image is generated based on a range-Doppler approach.

11. The method of claim 1, wherein the image includes a dynamic image or a plurality of static images at different time instants.

12. The method of claim 11, wherein the model of each of the one or more objects includes a model of a target static object, the method further comprising:
identifying, by the at least one processor, the target static object in the image based on the model of the target static object; and
constructing, by the at least one processor, an electronic fence based on the target static object.

13. The method of claim 11, wherein the model of each of the one or more objects includes at least one posture model of a moving human body, the method further comprising:
identifying, by the at least one processor, at least one posture of the moving human body in the image based on the at least one posture model of the moving human body.

14. The method of claim 1, wherein the model of each of the one or more objects includes a gait model of at least one target human body, the method further comprising:
identifying, by the at least one processor, the at least one target body in the image based on the gait model of the at least one target human body.

15. The method of claim 14, wherein the gait model includes at least one of a step size, a gait frequency, or a gait phase.

16. The method of claim 11, wherein the model of each of the one or more objects includes a physiological parameter model of a human body, the method further comprising:
determining, by the at least one processor, a physiological parameter of the human body in the image based on the physiological parameter model of the human body, wherein the physiological parameter includes at least one of a heart rate, a respiratory parameter, or a blood pressure.

17-31. (canceled)

32. A microwave identification system, comprising:
at least one storage device used to store instructions; and
at least one processor; wherein when the processor performs the instructions, the at least one processor is directed to:
obtain microwave data;
generate an image of one or more objects based on the microwave data;
obtain a model of each of the one or more objects; and
identify, based on the model for each of the one or more objects, the one or more objects in the image of the one or more objects.

33-37. (canceled)

38. The system of claim 32, wherein to identify the one or more objects in the image of the one or more objects based on the model for each of one or more objects, the at least one processor is directed to:
extract one or more features from the image;
compare the one or more features with a feature of the model for each of the one or more objects; and
identify the one or more objects in the image based on the comparison.

39. The system of claim 38, the system further:
determines that the one or more objects in the image includes a human body; and
generates, warning information in response to determining that the one or more objects in the image includes a human body.

40-47. (canceled)

48. A computer-readable storage medium storing computer instructions, the computer instruction makes a computer implement a method, comprising:
obtaining microwave data;
generating, based on the microwave data, an image of one or more objects;
obtaining a model of each of the one or more objects; and
identifying, based on the model for each of the one or more objects, the one or more objects in the image of the one or more objects.
